(19) United States
(12) Patent Application Publication
(10) Pub. No.: US 2019/0013163 A1
(43) Pub. Date: Jan. 10, 2019

(54) LUMINOUS KEYBOARD

(71) Applicant: Primax Electronics Ltd., Taipei (TW)

(72) Inventor: Chung-Yuan CHEN, Taipei (TW)

(21) Appl. No.: 15/835,908

(22) Filed: Dec. 8, 2017

(30) Foreign Application Priority Data
Jul. 7, 2017 (TW) 106122893

(51) Int. Cl. H01H 13/83; H01H 13/7065; H01H 13/02; H01H 13/14

(52) U.S. Cl. CPC H01H 13/83; H01H 13/7065; H01H 2219/06; H01H 13/14; H01H 2219/036; H01H 13/023

(57) ABSTRACT

A luminous keyboard includes a key structure, a supporting plate, a switch circuit board, a backlight module and a top-view light-emitting element. The switch circuit board is located over the supporting plate. The backlight module is located under the supporting plate. The top-view light-emitting element emits a light beam. The backlight module includes a top reflector, a bottom reflector, and a light guide plate between the top reflector and the bottom reflector. The top-view light-emitting element is inserted into a light guide plate opening through a bottom reflector opening. After the light beam is introduced into the light guide plate, the light beam is guided to the supporting plate opening by plural microstructures of the light guide plate. After the light beam is transmitted through the supporting plate opening and the switch circuit board, the light beam is projected to the key structure.

### FIELD OF THE INVENTION

The present invention relates to a keyboard, and more particularly to a luminous keyboard with an illuminating function.

### BACKGROUND OF THE INVENTION

Generally, the widely-used peripheral input device of a computer system includes for example a mouse device, a keyboard, a trackball device, or the like. Via the keyboard, characters and symbols can be inputted into the computer system directly. As a consequence, most users and most manufacturers of input devices pay much attention to the development of keyboards.

FIG. 1 is a schematic top view illustrating the outer appearance of a conventional keyboard. As shown in FIG. 1, there are plural keys 10 on a surface of the conventional keyboard 1. These keys 10 are classified into several types, e.g. ordinary keys 101, numeric keys 102 and function keys 103. When one of these keys 10 is depressed by the user's finger, a corresponding signal is issued to the computer, and thus the computer executes a function corresponding to the depressed key. For example, when an ordinary key 101 is depressed, a corresponding English letter or symbol is inputted into the computer. When a numeric key 102 is depressed, a corresponding number is inputted into the computer. In addition, the function keys 103 (F1˜F12) can be programmed to provide various functions. For example, the conventional keyboard 1 is a keyboard for a notebook computer.

With the maturity of the computing technologies, the keyboard manufacturers make efforts in designing novel keyboards with special functions in order to meet diversified requirements of different users. For this reason, luminous keyboards are favored by users. Hereinafter, the inner structure of the luminous keyboard will be illustrated in more details. FIG. 2 is a schematic cross-sectional view illustrating a conventional luminous keyboard. As shown in FIG. 2, the conventional luminous keyboard 2 comprises plural key structures 20, a membrane switch circuit member 21, a light guide plate 22, an illumination module 23, a supporting plate 24 and a reflecting plate 25. Each key structure 20 comprises a keycap 201, a scissors-type connecting element 202 and an elastic element 203. From top to bottom, the keycap 201, the scissors-type connecting element 202, the elastic element 203, the membrane switch circuit member 21, the supporting plate 24, the light guide plate 22 and the reflecting plate 25 of the conventional luminous keyboard 2 are sequentially shown. The supporting plate 24 is arranged between the membrane switch circuit member 21 and the light guide plate 22 for supporting the keycap 201, the scissors-type connecting element 202, the elastic element 203 and the membrane switch circuit member 21.

In the key structure 20, the keycap 201 is exposed outside the conventional luminous keyboard 2, so that the keycap 201 can be depressed by the user. The scissors-type connecting element 202 is used for connecting the keycap 201 and the supporting plate 24. The elastic element 203 is penetrated through the scissors-type connecting element 202. In addition, both ends of the elastic element 203 are contacted with the keycap 201 and the membrane switch circuit member 21, respectively. The membrane switch circuit member 21 comprises an upper wiring board 211, a separation layer 212, and a lower wiring board 213. The upper wiring board 211, the separation layer 212 and the lower wiring board 213 are all made of a light-transmissible material. The light-transmissible material is for example polycarbonate (PC) or polyethylene (PE). The upper wiring board 211 comprises plural upper conductive parts 2111. The separation layer 212 is located under the upper wiring board 211. Moreover, the separation layer 212 comprises plural separation layer openings 2121 corresponding to the plural upper conductive parts 2111. The lower wiring board 213 is located under the separation layer 212. Moreover, the lower wiring board 213 comprises plural lower conductive parts 2131 corresponding to the plural upper conductive parts 2111. Moreover, plural key switches 214 are defined by the plural lower conductive parts 2131 and the plural upper conductive parts 2111 collaboratively.

The illumination module 23 comprises an illumination circuit board 231 and plural light-emitting elements 232. For clarification and brevity, only two light-emitting elements 232 are shown in the drawing. The illumination circuit board 231 is located under the membrane switch circuit member 21 for providing electric power to the plural light-emitting elements 232. The plural light-emitting elements 232 are disposed on the illumination circuit board 231. In addition, the plural light-emitting elements 232 are inserted into plural reflecting plate openings 251 of the reflecting plate 25 and plural light guide plate openings 221 of the light guide plate 22, respectively. By acquiring the electric power, the plural light-emitting elements 232 are driven to emit plural light beams B. Moreover, the plural light beams B are introduced into the light guide plate 22. For example, the plural light-emitting elements 232 are side-view light emitting diodes. The light guide plate 22 is used for guiding the plural light beams B to the keycaps 201. The reflecting plate 25 is located under the light guide plate 22 for reflecting the plural light beams B. Consequently, the plural light beams B are directed upwardly, and the utilization efficiency of the light beams B is enhanced. The two lateral edges 252 of the reflecting plate 25 are bent upwardly to enclose plural lateral edges 222 of the light guide plate 22. For clarification and brevity, only one lateral edge 252 of the reflecting plate 25 is shown in the drawing. Due to the lateral edges 252 of the reflecting plate 25, the problem of causing light leakage through the lateral edges 222 of the light guide plate 22 will be eliminated.

In the conventional luminous keyboard 2, each keycap 201 has a light-outputting zone 2011. The light-outputting zone 2011 is located at a character region or a symbol region of the keycap 201. Moreover, the position of the light-outputting zone 2011 is aligned with the position of a corresponding light-guiding dot 223 of the light guide plate 22. The light beams can be guided upwardly to the light-outputting zone 2011 by the corresponding light-guiding dot 223. After the plural light beams B are transferred within the light guide plate 22 and projected on the light-guiding dots 223, the light beams B are guided by the light-guiding dots 223 and projected upwardly. The upwardly-projected portions of the light beams B are sequentially transmitted through plural supporting plate openings 241 of the supporting plate 24 and the membrane switch circuit member 21 and transmitted through the plural light-outputting zones 2011 of the keycaps 201 so as to illuminate the character regions or the symbol regions of the keycaps 201. Under this circumstance, the illuminating function is achieved.

However, the conventional luminous keyboard still has some drawbacks. For example, all of the key structures of the luminous keyboard are simultaneously illuminated. In some situations, the user prefers to control illumination of respective key structures. For example, when the luminous keyboard is applied to an electronic sports product, it is necessary to illuminate one key structure but not illuminate another key structure. The use of the conventional luminous keyboard 2 cannot meet the user's requirement. For meeting the user's requirement, the luminous keyboard uses top-view light emitting diodes. That is, a single top-view light emitting diode is located under the keycap of one key structure. Since the illumination of each top-view light emitting diode is independently controlled, the use of the top-view light emitting diode can meet the user's requirement. The light beam emitted by the top-view light emitting diode is projected directly and upwardly to the corresponding keycap. Since the light beam from the top-view light emitting diode is centralized, the luminance uniformity is usually unsatisfied. As shown in FIG. 1, the symbol regions 1041˜1044 (e.g., character regions or number regions) of the key structure 104 are located at the periphery region of the keycap. Consequently, the luminance uniformity is usually unsatisfied.

In other words, the conventional luminous keyboard needs to be further improved.

### SUMMARY OF THE INVENTION

An object of the present invention provides a luminous keyboard for controlling illumination of individual key structures and producing enhanced luminance uniformity of each key structure.

In accordance with an aspect of the present invention, there is provided a luminous keyboard. The luminous keyboard includes a key structure, a supporting plate, a switch circuit board, a backlight module and a top-view light-emitting element. The key structure is at least partially exposed outside the luminous keyboard. The supporting plate is located under the key structure, and includes a supporting plate opening. The key structure is connected with the supporting plate. The switch circuit board is located over the supporting plate. When the switch circuit board is triggered by the key structure, a key signal is generated. The backlight module is located under the supporting plate. The backlight module includes a top reflector, a bottom reflector and a light guide plate. The light guide plate is arranged between the top reflector and the bottom reflector. The light guide plate includes a light guide plate opening corresponding to the bottom reflector opening and includes plural microstructures. The top-view light-emitting element is located under the key structure, and inserted into the light guide plate opening through the bottom reflector opening. After a light beam emitted by the top-view light-emitting element is introduced into the light guide plate, the light beam is transferred within the light guide plate and guided to the supporting plate opening by the plural microstructures. After the light beam is transmitted through the supporting plate opening and the switch circuit board, the light beam is projected to the key structure.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic top view illustrating the outer appearance of a conventional keyboard;

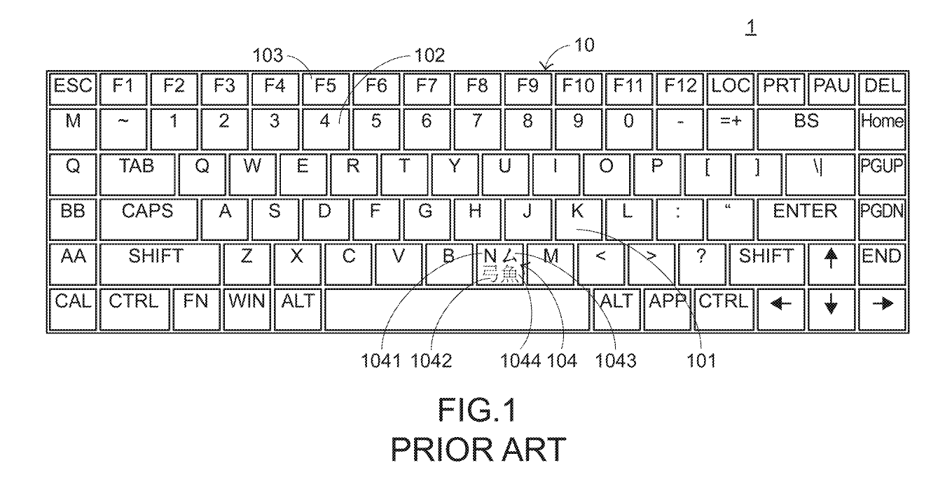

FIG. 2 is a schematic cross-sectional view illustrating a conventional luminous keyboard;

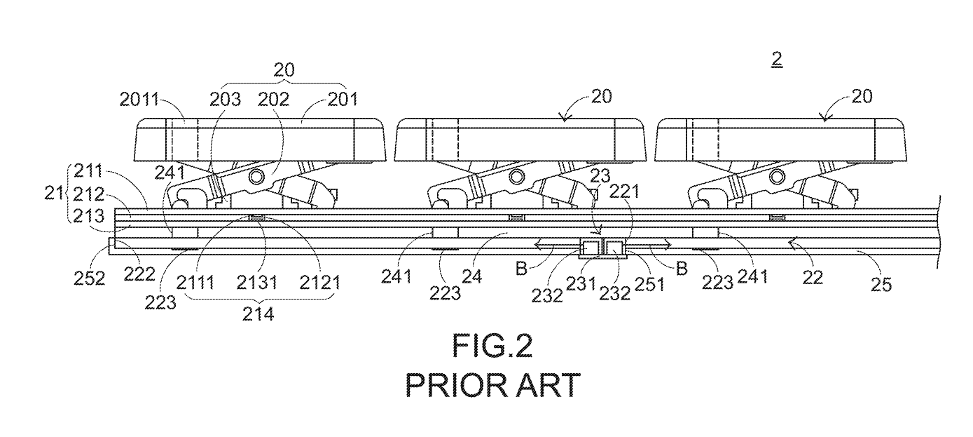

FIG. 3 is a schematic cross-sectional view illustrating a portion of a luminous keyboard according to a first embodiment of the present invention;

FIG. 4 is a schematic exploded view illustrating the switch circuit board of the luminous keyboard according to the first embodiment of the present invention; and

FIG. 5 is a schematic cross-sectional view illustrating a portion of a luminous keyboard according to a second embodiment of the present invention.

### DETAILED DESCRIPTION OF THE PREFERRED EMBODIMENT

For overcoming the drawbacks of the conventional technology, the present invention provides a luminous keyboard. The structure of the luminous keyboard will be described as follows.

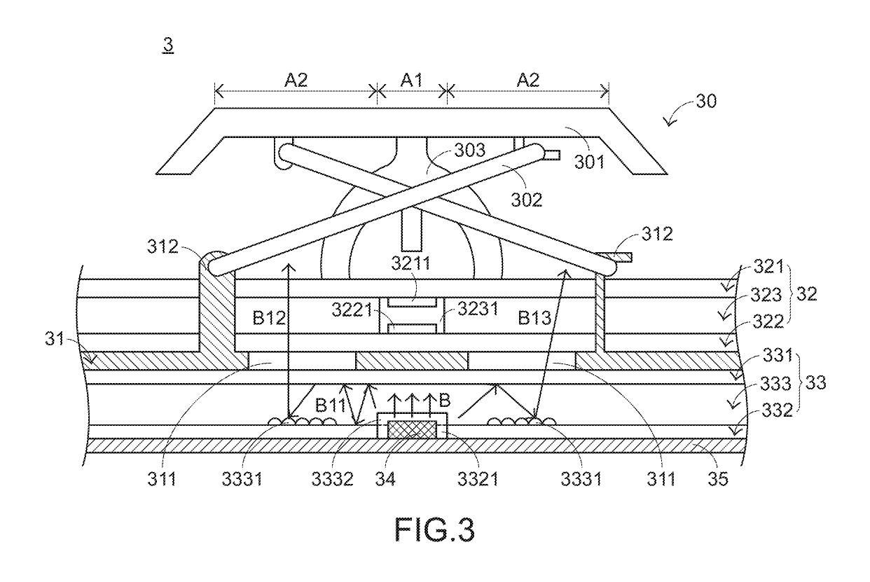

FIG. 3 is a schematic cross-sectional view illustrating a portion of a luminous keyboard according to a first embodiment of the present invention. As shown in FIG. 3, the luminous keyboard 3 comprises plural key structures 30, a supporting plate 31, a switch circuit board 32, a backlight module 33, plural top-view light-emitting elements 34 and an illumination circuit board 35. For succinctness, only one key structure 30 and only one top-view light-emitting element 34 are shown in the drawing. Each top-view light-emitting element 34 is aligned with one key structure 30. At least one part of each key structure 30 is exposed outside the luminous keyboard 3. Consequently, the key structure 30 can be depressed by the user. The supporting plate 31 is located under the plural key structures 30 and connected with the plural key structures 30. Moreover, the supporting plate 31 comprises plural supporting plate openings 311 and plural hooks 312. The switch circuit board 32 is disposed on the supporting plate 31. When the switch circuit board 32 by is triggered by at least one of the plural key structures 30, a corresponding key signal is generated. The backlight module 33 is located under the supporting plate 31. In an embodiment, the backlight module 33 comprises a top reflector 331, a bottom reflector 332 and a light guide plate 333. The light guide plate 333 is arranged between the top reflector 331 and the bottom reflector 332. The bottom reflector 332 comprises plural bottom reflector openings 3321 corresponding to the plural key structures 30. For succinctness, only one bottom reflector opening 3321 is shown in the drawing. The light guide plate 333 comprises plural microstructures 3331 and plural light guide plate openings 3332. The plural light guide plate openings 3332 are aligned with the corresponding bottom reflector openings 3321.

Each top-view light-emitting element 34 is located under the corresponding key structure 30. Moreover, each top-view light-emitting element 34 is penetrated through corresponding bottom reflector opening 3321 and inserted into the corresponding light guide plate opening 3332. The plural top-view light-emitting elements 34 emit plural light beams B upwardly. The illumination circuit board 35 is located under the backlight module 33 for supporting the plural top-view light-emitting elements 34. Moreover, the illumination circuit board 35 is electrically connected with the plural top-view light-emitting elements 34. Preferably but not exclusively, the plural top-view light-emitting elements 34 are top-view light emitting diodes, and the illumination circuit board 35 is a printed circuit board (PCB) or a flexible printed circuit (FPC). The top-view light emitting diodes are monochromatic light emitting diodes or polychromatic light emitting diodes (RGB LEDs). In other words, each top-view light-emitting element 34 of the luminous keyboard 3 is a light emitting diode capable of emitting a red light beam, a green light beam and/or a blue light beam. Moreover, the red light beam, the green light beam and the blue light beam at a specified ratio may be mixed to produce a desired color light.

As shown in FIG. 3, each key structure 30 comprises a keycap 301, a connecting element 302 and a triggering element 303. The keycap 301 is located over the supporting plate 31 and exposed outside the luminous keyboard 3. The connecting element 302 is connected between the corresponding keycap 301 and the plural hooks 312 of the supporting plate 31. Consequently, the corresponding keycap 301 is moved upwardly or downwardly relative to the supporting plate 31. Preferably but not exclusively, the connecting element 302 is a scissors-type connecting element. The triggering element 303 is arranged between the corresponding keycap 301 and the switch circuit board 32. While the keycap 301 is depressed and moved downwardly to push the triggering element 303, the triggering element 303 is subjected to deformation to trigger the switch circuit board 32. When the keycap 301 is no longer depressed, no external force is applied to the keycap 301. In response to the elasticity of the triggering element 303, the triggering element 303 is restored to its original shape to provide an upward elastic restoring force to the keycap 301. In response to the upward elastic restoring force, the keycap 301 is returned to its original position where it is not depressed.

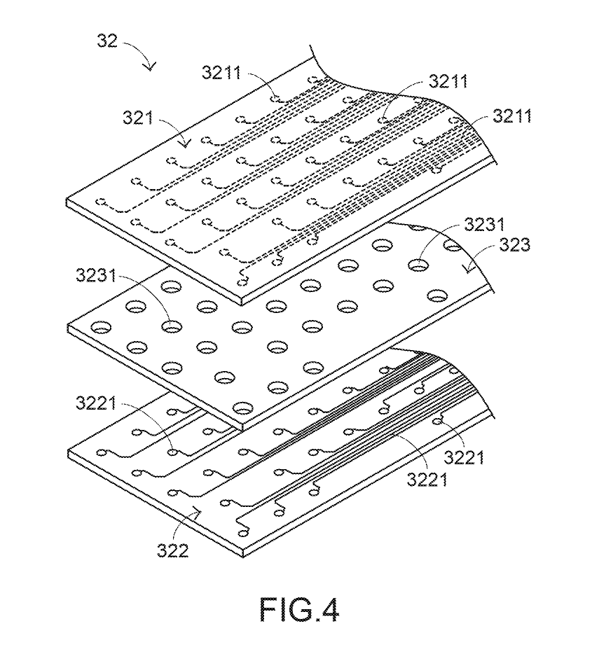

FIG. 4 is a schematic exploded view illustrating the switch circuit board of the luminous keyboard according to the first embodiment of the present invention. Please refer to FIGS. 3 and 4. The switch circuit board 32 comprises an upper wiring board 321, a lower wiring board 322 and a separation layer 323. The upper wiring board 321 is contacted with the triggering element 303. Moreover, the upper wiring board 321 comprises plural upper conductive parts 3211. The plural upper conductive parts 3211 are disposed on a bottom surface of the upper wiring board 321. The lower wiring board 322 is located under the upper wiring board 321. Moreover, the lower wiring board 322 comprises plural lower conductive parts 3221. The plural lower conductive parts 3221 are disposed on a top surface of the lower wiring board 322. The separation layer 323 is arranged between the upper wiring board 321 and the lower wiring board 322. Moreover, the separation layer 323 comprises plural separation layer openings 3231 corresponding to the plural keycaps 301. The upper conductive parts 3211 and the plural lower conductive parts 3221 are separated from each other by the separation layer 323. Moreover, a key switch (not shown) is defined by the corresponding upper conductive part 3211, the corresponding separation layer opening 3231 and the corresponding lower conductive part 3221 collaboratively. Each key switch is aligned with one key structure 30. When the upper wiring board 321 is triggered by the triggering element 303, the corresponding upper conductive part 3211 is penetrated through the corresponding separation layer opening 3231 and contacted with the corresponding lower conductive part 3221. Consequently, the switch circuit board 32 is electrically conducted to generate the corresponding key signal. In this embodiment, each of the upper conductive parts 3211 and the lower conductive parts 3221 are circular conductive blocks with a light-transmissible region (e.g., a hollow region). It is noted that the light-transmissible region is not restricted to the hollow region and the shapes of the upper conductive parts 3211 and the lower conductive parts 3221 are not restricted to the circular shapes. For example, in some other embodiments, each of the upper conductive parts 3211 and the lower conductive parts 3221 is a triangular conductive block with a middle hollow region, a rectangular conductive block with a middle hollow region or a rhombus conductive block with a middle hollow region.

Please refer to FIG. 3 again. Each key structure of the luminous keyboard 3 comprises a first region A1 and a second region A2. Moreover, the keycap 301 of each key structure comprises light-transmissible symbol regions (not shown) such as character regions or number regions. The plural supporting plate openings 311 of the supporting plate 31 and the symbol regions of the keycaps 301 are aligned with the second regions A2 of the corresponding key structures 30. The top-view light-emitting elements 34 are aligned with the first regions Al of the corresponding key structures 30. Preferably but not exclusively, the first region A1 is a middle region of the keycap 301, and the second region A2 is a periphery region that is arranged around the middle region.

The optical paths of the luminous keyboard 3 will be described as follows. After one top-view light-emitting element 34 is driven to emit the light beam B, the light beam B is introduced into the light guide plate 333. Due to the arrangement of the top reflector 331 and the bottom reflector 332, the light beam B is transferred within the light guide plate 333. That is, the portion of the light beam B scattered upwardly from the light guide plate 333 is reflected by the top reflector 331, and the portion of the light beam B scattered downwardly from the light guide plate 333 is reflected by the bottom reflector 332. See the optical path B11 of the light beam as shown in FIG. 3. When the portion of the light beam transferred within the light guide plate 333 is projected on the microstructures 3331 of light guide plate 333, the light beam is guided to the corresponding supporting plate openings 311 by the microstructures 3331. See the optical path B12 of the light beam and the optical path B13 of the light beam as shown in FIG. 3. The portion of the light beam along the optical path B12 and the optical path B13 is transmitted through the corresponding supporting plate opening 311 and the switch circuit board 32 sequentially and projected to the keycap 301 of the corresponding key structure 30. After the light beam is transmitted through the keycap 301, the symbol regions (e.g., the character regions or the number regions) of the keycap 301 are illuminated. The operating principles of guiding the light beam along the desired direction are well known to those skilled in the art, and are not redundantly described herein.

As mentioned above, the top-view light-emitting element 34 is aligned with a small portion of the key structure 30 (i.e., the first region A1). However, the top-view light-emitting element 34 has an inherent problem. For example, the projecting effect of the light beam emitted by the top-view light-emitting element 34 is very centralized. Since the top-view light-emitting element 34 is inserted into the backlight module 33, the light beam B from the top-view light-emitting element 34 can be guided by the backlight module 33. Moreover, since the supporting plate opening 311 is aligned with the symbol regions (e.g., the character regions or the number regions) of the keycap 301, the second region A2 of the key structure 30 that is not directly projected by the light beam from the top-view light-emitting element 34 have sufficient luminance and are uniformly illuminated. In comparison with the conventional technology, the luminance uniformity of the region that is directly projected by the light beam from the top-view light-emitting element of the luminous keyboard of the present invention will be enhanced.

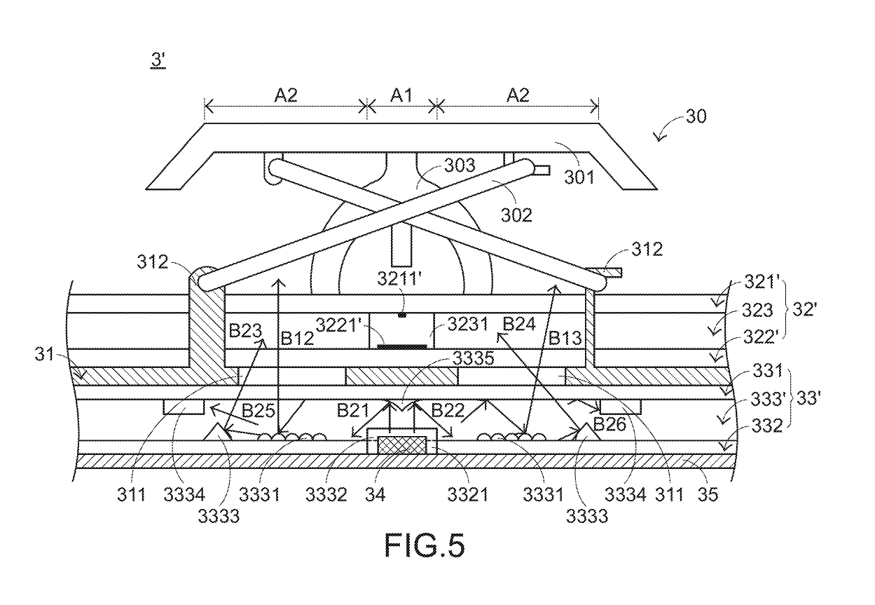

FIG. 5 is a schematic cross-sectional view illustrating a portion of a luminous keyboard according to a second embodiment of the present invention. Except for the following two aspects, the structures of the luminous keyboard 3′ are substantially identical to those of the luminous keyboard 3 of the first embodiment. The identical aspects are not redundantly described herein. In comparison with the first embodiment, the light guide plate 333′ of the backlight module 33′ comprises plural sheltering structures 3333, plural light-absorbing structures 3334 and plural light-guiding structures 3335. The plural light-guiding structures 3335 are aligned with the corresponding top-view light-emitting elements 34. For succinctness, only two sheltering structures 3333, two light-absorbing structures 3334 and one light-guiding structure 3335 are shown in the drawing. Each sheltering structure 3333 and each light-absorbing structure 3334 are arranged beside the corresponding top-view light-emitting element 34 and separated from the corresponding top-view light-emitting element 34 by specified distances. That is, the supporting plate opening 311 of the supporting plate 31 is arranged between the corresponding light guide plate opening 3332 and the corresponding sheltering structure 3333. The light-guiding structure 3335 is located near an overlying position of the corresponding top-view light-emitting element 34.

After one top-view light-emitting element 34 is driven to emit the light beam B, the light beam B is introduced into the light guide plate 333. Then, the light beam B is guided by the corresponding light-guiding structure 3335. A first portion of the light beam B scattered upwardly from the light guide plate 333 is guided to a first side of the light guide plate 333 along an optical path B21 (see FIG. 5). A second portion of the light beam B scattered upwardly from the light guide plate 333 is guided to a second side of the light guide plate 333 along an optical path B22 (see FIG. 5). The sheltering structure 3333 is used for sheltering the light beam to prevent from light leakage to the adjacent key structure 30. Due to the sheltering structure 3333, a portion of the light beam B is propagated along the optical path B23 and the optical path B24 (see FIG. 5). A portion of the light beam propagated along the optical path B25 and the optical path B26 is absorbed by the light-absorbing structure 3334.

The light-guiding structure 3335 is used for guiding the light beam from the top-view light-emitting element 34 to the two sides of the light guide plate 333. Consequently, the light utilization efficiency is enhanced. The sheltering structure 3333 and the light-absorbing structure 3334 are used for preventing light leakage. That is, by the sheltering structure 3333 and the light-absorbing structure 3334, the light beam from the top-view light-emitting element 34 is not transferred to the adjacent key structures 30. Consequently, the light beams emitted by the top-view light-emitting elements 34 of the adjacent key structures do not interfere with each other. Preferably but not exclusively, the light-absorbing structure 3334 is light-absorbing ink.

In comparison with the first embodiment, the upper conductive part 3211′ of the upper wiring board 321′ of the switch circuit board 32′ is a first conductive strip, and the lower conductive part 3221′ of the lower wiring board 322′ of the switch circuit board 32′ is a second conductive strip. Moreover, the first conductive strip and the second conductive strip are perpendicular to each other. Consequently, the key switch has a cross shape. In comparison with the conductive blocks of the first embodiment, the conductive strips of the upper conductive part 3211′ and the lower conductive part 3221′ have smaller areas. When the upper conductive part 3211′ is contacted with the lower conductive part 3221′, the upper conductive part 3211′ and the lower conductive part 3221′ are in a point-to-point contact relationship. Since the fraction of the light beam to be transmitted through the switch circuit board 32′ is increased, the amount of the light beam to be projected to the key structure 30 is increased.

From the above description, the luminous keyboard of the present invention uses the top-view light-emitting elements. The top-view light-emitting elements and the key structures are in a one-to-one relationship. Consequently, the illumination of individual key structures can be controlled. Moreover, the colors of different key structures may be controlled to be identical or different. The luminous keyboard of the present invention has many benefits, including the simple control circuit, power-saving efficacy, the simple fabricating process, cost-effectiveness and high throughput. The top-view light-emitting elements are inserted into the backlight module, and the light beams from the top-view light-emitting elements are guided by the backlight module. The supporting plate openings are aligned with the symbol regions (e.g., character region or number regions) of the corresponding keycaps. Even if the light beams from the top-view light-emitting elements are not directly projected on the symbol regions, the symbol regions have sufficient luminance values and are uniformly illuminated.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all modifications and similar structures.

What is claimed is:

1. A luminous keyboard, comprising:
a key structure, wherein the key structure is at least partially exposed outside the luminous keyboard;
a supporting plate located under the key structure, and comprising a supporting plate opening, wherein the key structure is connected with the supporting plate;
a switch circuit board located over the supporting plate, wherein when the switch circuit board is triggered by the key structure, a key signal is generated;
a backlight module located under the supporting plate, and comprising a top reflector, a bottom reflector and a light guide plate, wherein the light guide plate is arranged between the top reflector and the bottom reflector, and the light guide plate comprises a light guide plate opening corresponding to the bottom reflector opening and comprises plural microstructures; and
a top-view light-emitting element located under the key structure, and inserted into the light guide plate opening through the bottom reflector opening, wherein after a light beam emitted by the top-view light-emitting element is introduced into the light guide plate, the light beam is transferred within the light guide plate and guided to the supporting plate opening by the plural microstructures, wherein after the light beam is transmitted through the supporting plate opening and the switch circuit board, the light beam is projected to the key structure.

2. The luminous keyboard according to claim 1, wherein the top-view light-emitting element is aligned with a first region of the key structure, and the supporting plate opening is aligned with a second region of the key structure.

3. The luminous keyboard according to claim 2, wherein the first region is a middle region of the key structure, and the second region is a periphery region that is arranged around the middle region.

4. The luminous keyboard according to claim 1, wherein the light guide plate further comprises a light-guiding structure, and the light-guiding structure is located over the top-view light-emitting element, wherein after the light beam from the top-view light-emitting element is introduced into the light guide plate and projected on the light-guiding structure, a first portion of the light beam is guided to a first side of the light guide plate and a second portion of the light beam is guided to a second side of the light guide plate.

5. The luminous keyboard according to claim 1, wherein the light guide plate further comprises a sheltering structure, and the sheltering structure is arranged beside the top-view light-emitting element, so that the supporting plate opening is arranged between the sheltering structure and the light guide plate opening of the light guide plate, wherein while the light beam is transferred within the light guide plate, a portion of the light beam is sheltered by the sheltering structure.

6. The luminous keyboard according to claim 1, wherein the light guide plate further comprises a light-absorbing structure, and the light-absorbing structure is arranged beside the top-view light-emitting element, so that the supporting plate opening is arranged between the light-absorbing structure and the light guide plate opening of the light guide plate, wherein while the light beam is transferred within the light guide plate, a portion of the light beam is absorbed by the light-absorbing structure.

7. The luminous keyboard according to claim 1, further comprising an illumination circuit board under the bottom reflector, wherein the top-view light-emitting element is supported by the illumination circuit board, and the illumination circuit board is electrically connected with the top-view light-emitting element.

8. The luminous keyboard according to claim 1, wherein the top-view light emitting diode is a polychromatic light emitting diode (RGB LED).

9. The luminous keyboard according to claim 1, wherein the key structure comprises:
a keycap located over the supporting plate and exposed outside the luminous keyboard;
a connecting element arranged between the keycap and the supporting plate, wherein the keycap is connected with the supporting plate through the connecting element, so that the keycap is movable upwardly or downwardly relative to the supporting plate; and
a triggering element arranged between the keycap and the switch circuit board, wherein while the keycap is depressed to push the triggering element, the switch circuit board is triggered by the triggering element.

10. The luminous keyboard according to claim 1, wherein the switch circuit board comprises:
an upper wiring board comprising an upper conductive part;
a lower wiring board located under the upper wiring board, wherein the lower wiring board comprises a lower conductive part; and
a separation layer arranged between the upper wiring board and the lower wiring board, wherein the upper conductive part and the lower conductive part are separated from each other by the separation layer, and the separation layer comprises a separation layer opening,
wherein when the upper wiring board is triggered by the triggering element, the upper conductive part is penetrated through the separation layer opening and contacted with the lower conductive part, so that the switch circuit board generates the key signal.

11. The luminous keyboard according to claim 10, wherein the upper conductive part and the lower conductive part are conductive blocks.

12. The luminous keyboard according to claim 10, wherein the upper conductive part is a first conductive strip, and the lower conductive part is a second conductive strip, wherein the first conductive strip and the second conductive strip are perpendicular to each other.
